(19) United States
(12) Patent Application Publication
(10) Pub. No.: US 2023/0354960 A1
(43) Pub. Date: Nov. 9, 2023

(54) PRODUCTION OF A FOAM-MOLDED SHOE COMPONENT BY WAY OF PRE-TREATMENT IN AN AUTOCLAVE

(71) Applicant: ON CLOUDS GMBH, ZURICH (CH)

(72) Inventors: Jean-Philippe ROMAIN, Zurich (CH); Sebastian ROSCHER, Zurich (CH); Nils Arne ALTROGGE, Zurich (CH); Ilmarin HEITZ, Zurich (CH)

(73) Assignee: ON CLOUDS GMBH, Zurich (CH)

(21) Appl. No.: 18/026,282

(22) PCT Filed: Sep. 8, 2021
(86) PCT No.: PCT/EP2021/074682

§ 371 Date: Mar. 14, 2023

(30) Foreign Application Priority Data
Sep. 15, 2020 (CH) 01162/20

(51) Int. Cl. A43B 13/18; B29C 44/02; B29C 44/34; A43B 13/04; B29C 44/44

(52) U.S. Cl. CPC A43B 13/187; A43B 13/04; B29C 44/02; B29C 44/3446; B29C 44/3461; B29C 44/3469; B29C 44/445; B29K 2105/04

(57) ABSTRACT

A method for producing a foam-molded shoe component includes the steps of: providing a polymer granulate; pre-treating the polymer granulate including binding to or in the polymer granulate a physical propellant in an autoclave at a first pressure and a first temperature; and foaming the pre-treated polymer granulate including melting the polymer granulate to produce a molten polymer composition, and foaming the molten polymer composition as a result of the expansion of the physical propellant.

### FIELD OF THE INVENTION

The present invention relates to the technical field of shoe production, in particular foamed shoe components, and relates to a method for production of a foam-molded shoe component.

### DISCUSSION OF RELATED ART

Foam-molded materials contain a plurality of pores, respectively cells in the foam material, and because of this, foam-molded materials are particularly suitable for use as cushioning elements, for example shoe soles. Such foams are typically produced with the aid of propellant additives. In this context, a polymer material, typically a thermoplastic polymer such as thermoplastic polyurethane, is melted in an extruder. A propellant additive is typically mixed in with the polymer material, which expands under predefined conditions, and is then able to form the pores or cells in the foam-molded material. Regarding propellant additives, a difference is typically made between chemical and physical propellants. Physical propellants are propellants which are able to expand or transform from the liquid or solid aggregate state into the gaseous state directly due to a change of physical parameters such as pressure and temperature. Known physical propellants are CO2, nitrogen, water, hydrocarbons such as propane, butane, pentane or hexane, and hydrocarbon derivatives, in particular halogenated derivatives such as dichloromethane, chloroform or hydrofluorocarbons. Chemical propellants are propellants from which a propellant can be released in situ by a chemical reaction under predetermined conditions. These include for example diazo compounds (release of N2), metal hydrides (release of H2) and carbonates (release of CO2).

Among the physical propellants, those which are present as supercritical fluids (SCF) have emerged as a special case. The most well-known process in which SCFs are used is the “MuCell® process”. In this process, a polymer composition is mixed with a SCF in an extruder to form a single-phase mixture, and then injected into a mold. A drop in pressure in the mold allows the propellant to dissolve from the polymer solution and evaporate, enabling microcells to form. Most commonly CO2 or nitrogen are used as the SCF.

### SUMMARY OF THE INVENTION

One challenge when foam-molding with propellant additives is controlling the pore size in the foam. Furthermore, although foaming with SCF is often used with thermoplastic polyurethane, it still presents difficulties with other materials, particularly with polyamides and copolymers thereof. Especially for shoe components, particularly in the area of running shoes, it is very important to be able to control the pore size in the foam, since on the one hand the objective is to obtain the lowest possible density, in order to reduce the total weight of the shoe, while on the other hand a high level of stability must be assured.

The general object to be addressed is therefore to advance the state of the art of producing foamed shoe components, and preferably entirely or partly overcoming one or more of the abovementioned drawbacks of the prior art. In advantageous embodiments, a method is provided in which the pore formation, in particular the pore size of the foamed material may be controlled more precisely. In further advantageous embodiments, a method is provided which makes it possible to produce a foamed shoe component that ensures low density but at the same time high stability. In further embodiments, a method for producing a foam-molded shoe component that is more energy efficient as compared to the prior art is provided.

The general object is achieved by the subject-matter of the independent claims. Further advantageous embodiments may follow from the dependent claims and the overall disclosure.

### DETAILED DESCRIPTION OF THE INVENTION

A first aspect relates to a method for producing a foam-molded shoe component, comprising the steps a. providing a polymer composition; b. pre-treating the polymer composition, comprising binding a physical propellant to or in the polymer composition at a first pressure and a first temperature in an autoclave; c. foaming the pre-treated polymer composition, comprising melting the polymer composition to produce a molten polymer composition, and foaming the molten polymer composition by expanding the propellant. The pre-treatment of the polymer composition in the autoclave enables a shoe component to be produced with low density, particularly a density from 0.05 g/cm3 to 0.5 g/cm3, preferably from 0.1 g/cm3 to 0.3 g/cm3.

The pre-treatment of the polymer composition with the propellant may comprise an impregnation, for example. In this context, the first propellant may bind on the surface of the polymer composition. This may include both the binding of the first propellant on the external surface, and the binding inside the polymer composition, wherein the propellant diffuses into the polymer composition. One of the advantages of the pre-treatment is that the foam-molded component presents less material shrinkage and distortion after production than a foam-molded component which is not pre-treated in an autoclave as described in step b.

The polymer composition may typically comprise a certain porosity, with the result that the first propellant is able to penetrate the individual polymer particles more readily. The first pressure is typically greater than normal pressure (1 bar) and the first temperature is typically higher than room temperature (25° C.). The person skilled in the art understands that unless otherwise specified the terms first pressure and first temperature (and second pressure, second temperature, etc.) can also comprise a temperature or pressure range, within which these parameters are maintained. Compared with a process without step b., the process according to the invention enables the production of a foam-molded shoe component with smaller pores in the foam and a considerably more homogenous distribution of the pores over the whole of the foam-molded component. Furthermore, the weight of the foam-molded component is reduced, which is beneficial for the runner, as he does not tire so quickly. Typical examples of suitable commercially available polymer compositions that can be used directly without any further pre-treatment are polyether block amide such as PEBAX 2533 (CAMPUSplastics), PEBAX 3533 (CAMPUSplastics), PEBAX 35R53 (CAMPUSplastics), or polyamide such as RILSAN BZMNO (CAMPUSplastics, PA11), VESTAMID E40-S3 (Evonik Industries AG, PA12), VESTAMID E47-S1 (Evonik Industries AG, PA12).

The polymer composition may have, for example, a water absorption capacity according to DIN 62 of 0.8 to 1.2. The density according to ISO 1183 of the polymer composition is typically between 0.9 and 1.1 g/cm3.

The expansion of the propellant is typically effected by a pressure drop, which may occur for example with the injection, respectively with the introduction of the molten polymer composition into a cavity of the molding tool, and/or also after it the injection, respectively introduction, for example by increasing the volume of the cavity in the molding tool, and/or by opening valves in the molding tool.

Step c. is typically carried out directly after the pre-treatment in step b. Moreover, step b. may represent the only step of the process in which a propellant, particularly a physical propellant is used. In particular, step c. and/or step a. is/are carried out in the absence of a further, additional propellant.

In some embodiments, the propellant is selected from CO2, N2 and mixtures thereof. CO2 is the preferred propellant, because due to its physical-chemical properties it is in particular more readily soluble in the polymer composition and is bound more effectively. This is particularly true when polar thermoplastic elastomers such as polyurethane, polyamide or derivatives thereof are used.

In some embodiments, 3 to 8% by weight, preferably 5 to 6% by weight CO2 relative to the polymer composition may be bound on or in the polymer composition during the pre-treatment in step b. In this way, a foam-molded shoe component with advantageous density of about 0.1 to 0.3 g/cm3 may be achieved.

In some embodiments, the foaming is carried out partially or entirely directly in the autoclave used in step b. In this context, an expansion of the propellant may be effected by reducing the pressure in the autoclave, in particular during or after step b. Partial foaming means that for example an additional foaming process may be carried out, in particular in a separate molding tool.

In some embodiments, the foaming is carried out partially or completely by means of compression molding or by means of injection molding, in a molding tool separate from the autoclave. Typically, the polymer composition that was pre-treated in step b. is therefore removed from the autoclave after the pre-treatment and placed in a corresponding, separate molding tool. This may be done fully automatically, semi-automatically, or manually.

In further embodiments, the molding tool may comprise a cavity whose volume can be increased, whose volume is increased during foaming. In this context, the cavity’s volume is typically increased during the injection or during the introduction of the polymer composition, and/or during the foaming. This may be effected for example by at least one movable wall of the molding tool, which wall may be moved in a controlled manner under control of a control unit, with the effect that the volume of the cavity becomes larger.

In some embodiments, the polymer composition is prepared in step a. using a further molding tool, in particular by injection molding. Consequently, a polymer granulate for example, in particular polyamide, a polyether block amide, a thermoplastic polyurethane, PET or polybutylene terephthalate (PBT), or mixtures thereof, may be used as the starting material for the polymer composition. In particular, the polymer composition may be prepared from polymer granulate by injection molding.

In some embodiments, the preparation of the polymer composition in step a. comprises the production of a preform of the shoe component, in particular of the shoe sole. In such embodiments, the polymer composition in step b. may therefore be present as a preform. The preform produced in step a. is preferably already portioned for the shoe component that is to be produced, i.e., the quantity of the polymer material needed for a shoe component that is to be produced is equal to the quantity of polymer material in the one preform.

The polymer composition, or the preform, is preferably present as a polymer block before the pre-treatment in step b. For example, it may be prepared by injection molding in step a, as described above.

In further embodiments, the first pressure in step b. has a value of 25 bar to 55 bar. Independently thereof, the first temperature in step b. may have a value from 0° C. to 150° C., in particular 40° C. to 120° C. The first temperature is preferably higher than room temperature, as this has the effect of accelerating the bonding of the physical propellants on and in the polymer composition. In particular, this also increases the penetration depth of the propellant into the particles of the polymer composition. This is advantageous because propellant which has penetrated the granulate remains bound for a considerably longer time period. The impregnated polymer composition can thus be stored longer and handled more easily, particularly transferred without losing significant quantities of the physical propellant. On the other hand, the first temperature must not be chosen too high, as this may cause polymer material, particularly thermoplastic material such as polyamide or polyether block amide (PEBA/PEBAX®) to be partially cleaved or decomposed. This represents a problem for use in the shoe area, since such a partially degenerated material can rapidly lead to inadequate cushioning during use of the shoe, and this may cause the wearer to experience knee, hip and ankle pain.

In some embodiments, the polymer composition may be dried before step b. by heating to a temperature of 30 to 130° C., in particular 60° C. to 120° C., especially 50° C. to 90° C., thereby increasing the quantity of propellant that is absorbed, respectively absorbable, in the polymer composition. Drying may be carried out until a residual moisture content not exceeding 0.02% remains.

In further embodiments, the first pressure and the first temperature are chosen or set such that the propellant is present in step b. as a supercritical fluid.

In further embodiments, the molding tool is equipped with a gas counterpressure apparatus, by means of which the polymer composition may be exposed to a counterpressure, preferably from >0 bar to 40 bar, particularly 1 bar to 40 bar, at least during a partial period of the injection and/or during a partial period of the foaming. With the application of a counterpressure, it is possible to slow or weaken the expansion of the propellant. This in turn enables to exercise a better control over the pore size and cell structure of the foam-molded component, and a more even distribution.

In further embodiments, in step b. the polymer composition is exposed to the first pressure and the first temperature for 2 hours to 8 hours, preferably for 2 hours to 5 hours. This time period is typically sufficient to bind a sufficient quantity of the first propellant on or in the polymer composition.

In some embodiments, the polymer composition pre-treated in step b. is introduced into the molding tool under a second pressure after step b. The second pressure may preferably be equal to at least 50%, particularly at least 75%, especially at least 90%, more particularly at least 95%, most particularly at least 100% of the first pressure. In this way, it is ensured that no significant quantity of the bonded propellant is desorbed during the transfer to the foam-molding system. In this context, it has been found that even a pressure equal to only 50% of the first pressure is sufficient to substantially prevent the desorption. The second pressure typically has a value not more than 200%, particularly not more than 150%, especially not more than 100%, of the first pressure.

In further embodiments, the polymer composition has a Shore hardness from 70 to 85. In some embodiments, the polymer composition has a density from 0.9 g/cm3 to 1.5 g/cm3, preferably 1.0 g/cm3 to 1.2 g/cm3. Typically, the denser the polymer composition, the lower the quantity of bonded first propellant. In this context, the use of polyamide and polyether block amide as the polymer composition is particularly advantageous with regard to uptake and absorption of the first physical propellant, particularly CO2.

In some embodiments, the polymer composition comprises a thermoplastic elastomer, in particular a polyamide, a polyether block amide or a thermoplastic polyurethane. Alternatively, the polymer composition may consist of a thermoplastic elastomer, in particular a polyamide, a polyether block amide or a thermoplastic polyurethane.

In further embodiments, the shoe component is a shoe sole, in particular a midsole. Such a shoe sole may be provided by configuring the cavity of the molding tool such that a shoe sole is formed during foam molding in step c.

In some embodiments, the shoe component produced in step c. may represent a blank shoe component, which is processed to obtain the finished shoe component in a subsequent process step. For example, this may be a blank shoe sole, which is then compressed by (further) compression molding to create a finished sole, or is then dyed or undergoes some other form of surface treatment.

A further aspect relates to a foam-molded shoe component, in particular a shoe sole, which is produced according to a method according to embodiments disclosed herein.

In some embodiments, the foam-molded shoe component may have a density from 0.05 g/cm3 to 0.5 g/cm3, preferably from 0.1 g/cm3 to 0.3 g/cm3.

In further embodiments, the foam-molded shoe component may have an Asker C hardness of 45 to 65.

1. A method for production of a foam-molded shoe component, comprising the steps:
a. providing a polymer composition;
b. pre-treating the polymer composition, comprising binding a physical propellant to or in the polymer composition in an autoclave at a first pressure and a first temperature;
c. foaming the pre-treated polymer composition, comprising melting the polymer composition to produce a molten polymer composition and foaming the molten polymer composition by expanding the physical propellant.

2. The method according to claim 1, wherein the physical propellant is selected from CO2, N2 and mixtures thereof.

3. The method Method according to claim 1, wherein the foaming is carried out partially or entirely directly in the autoclave used in step b.

4. The method according to claim 1 wherein the foaming is carried out partially or completely by means of compression molding or by means of injection molding in a molding tool separate from the autoclave.

5. The method according to claim 4 wherein the molding tool comprises a cavity whose volume can be increased, and of which the volume is increased during foaming.

6. The method according to claim 4 wherein the polymer composition is provided in step a. with a further molding tool, particularly by means of injection molding.

7. The method according to claim 1 wherein the polymer composition is present as polymer block before the pre-treatment in step b..

8. The method according to claim 1 wherein in step b. the first pressure is 35 bar to 55 bar, and/or the first temperature is 0° C. to 150° C., preferably 40° C. to 120° C.

9. The method according to claim 1, wherein the polymer composition is dried by heating to a temperature from 30 to 130° C. before step b..

10. The method according to claim 1 wherein the propellant in step b. is present as a supercritical fluid.

11. The method according to claim 4 wherein the molding tool is equipped with a gas counterpressure apparatus, by means of which the polymer composition is exposed to a counterpressure, preferably from >0 bar to 40 bar, at least during a partial period of the injection and/or during a partial period of the foaming.

12. The method according to claim 1, wherein in step b. the polymer composition is kept under the first pressure and at the first temperature for 2 hours up to 8 hours, preferably for 2 hours up to 5 hours.

13. The method according to claim 1, wherein the polymer composition has a Shore hardness from 70 to 85, and/or a density from 0.9 g/cm3 to 1.5 g/cm3, preferably 1.0 g/cm3 to 1.2 g/cm3.

14. The method according to claim 1, wherein the polymer composition comprises a thermoplastic elastomer, in particular a polyamide, a polyether block amide or a thermoplastic polyurethane.

15. The method according to claim 1, wherein the shoe component is a shoe sole, in particular a midsole, and wherein the shoe sole is preferably attached to a shoe upper in a further step, thereby producing a shoe, in particular a running shoe.

16. The method according to claim 1, wherein after the foaming of the molten polymer composition, the foam-molded shoe component produced by expansion of the propellant is post-formed by compression molding.

17. A foam-molded shoe-component, in particular a shoe sole, produced according to the method described in claim 1.

18. The foam-molded shoe-component, in particular a shoe sole according to claim 17, which has a density from 0.05 g/cm3 to 0.5 g/cm3, preferably from 0.1 g/cm3 to 0.3 g/cm3.

19. The foam-molded shoe-component, in particular a shoe sole according to claim 17, which has an Asker C hardness from 40 to 65.
